(19) United States
(12) Patent Application Publication
(10) Pub. No.: US 2001/0035387 A1
(43) Pub. Date: Nov. 1, 2001

(54) Universal baby bottle cap

(76) Inventor: Tami Leigh Sutcliffe-Noyd, Tahoe Vista, CA (US)

Correspondence Address: Tami L. Noyd, P.O. Box 2948, Kings Beach, CA, 96143, US

(21) Appl. No.: 09/792,588

(22) Filed: Feb. 26, 2001

Related U.S. Application Data
(60) Provisional application No. 60/186,228, filed on Mar. 1, 2000.

(51) Int. Cl. A61J 11/04

(52) U.S. Cl. 215/11.1; 604/235

(57) ABSTRACT

An apparatus to be used to convert the many standard bottles internationally into a baby bottle. Much, like the technology of the Sport Cap, my one-piece baby bottle adapter fits most standard bottles (usually 28 mm orifice), including most water bottles, globally. That is what term Universal in the Title of the invention means, Global. However, instead of a squirter (as seen on the Sport Cap), my cap has a nipple, therefore targeting a different consumer and market.

In addition to its nipple and universal fit, the Baby Bottle Cap can vary to empower endless other benefits: it can flare out decoratively at the bottom rim to prevent choking and can be utilized as a textured chewy teething surface. The flared decorative rim can also be a great advertising platform and can be designed in any number of shapes (flowers, bears, circular. . . but not limited to) and/or major themes (a massive network marketing opportunity.) Marketing campaigns could including but not be limited to movie advertisements, sports, concerts, other media events, fast food chains, baby companies, and especially drinking and flavored water companies.

The Baby Bottle Cap could be clipped onto a diaper bag or key chain, maybe coming in handy in an emergency situation. Not only will many of the store-bought drinks be utilized by this cap, but one could also add a packet of formula to a bottle of drinking water, screw on the Baby Bottle Cap, shake it up, and start feeding. Maybe there could be separate lines of Baby Bottle Caps specific to the Veterinary fields, or for hospitals, or famine relief. . . The avenues for the Baby Bottle Cap are endless, but best of all Kids will love them and parents will find them handy!

### CROSS REFERENCES TO RELATED PATENT APPLICATION

There was a Provisional Patent Application filed by me with the filing date of 03/01/00, number 60/186228, titled: Universal Baby Bottle Cap.

### STATEMENT REGARDING FED SPONSORED R & D

There has been no Federal Sponsoring for the Research & Development of this invention.

### REFERENCE TO MICROFICHE APPENDIX

There is no Microfiche Appendix for this invention.

### BACKGROUND OF THE INVENTION

1. Field of the Invention

This invention is in the general fields of Cap/Closure Packaging and Baby Bottle Nipple systems.

It is more particularly related to having a one-piece cap and nipple that fits most standard 28 mm water and soda bottles.

2. Description of the Prior Art

There is no prior art known to me utilizing a bottle cap fit and a baby bottle nipple as a closure to fit the standard bottle orifice, usually 28 mm. There is also no prior art known to me as utilizing a cap's rim as a marketing platform, as seen in a variation of Baby Bottle

Cap, nor is there any proir art known to me utilizing a cap's rim as a teething surface, while also functioning as a safety measure to prevent choking.

The most similar proir art that I've been able to find in my patent searches is the Gerber All In One. One Piece Nipple and Collar Assembly, threir product #1500078223, 1500078224 1500078225, 1500078226, 1500078227and 1500078228. The different Gerber product numbers refer to the various package availability, i.e number in package, fashion colors or clear, and/or different flow rates available. The Gerber product and my Baby Bottle Cap are similar in the they both offer a nipple already built into the colar/sleeve that readily adapts a bottle into a baby bottle, but mine differs in that it fits onto the many different 28 mm bottles, rather than only on the standard baby bottle, lessening the linitations until now of bottles that are readily available for use as a baby bottle.

### BRIEF SUMMARY OF THE INVENTION

### OBJECTS AND ADVANTAGES

In general, the claimed Universal Baby Bottle Cap is used to convert most any bottle into a baby bottle. The method by which I accomplish this is by providing a one piece unit that fits standard bottles (I believe this is the 28 mm standard size bottle orifice), including most water sport type bottles.

It is an object of this invention to provide a method and apparatus to allow toddlers to use the many standard bottles in the industry as a baby bottle.

Another object of this invention is to provide such a method and apparatus that is safe if judgement calls for a larger Baby Bottle Cap than the more simplified version (cap with nipple). I have designed a remedy for a more safe and fun Baby Bottle Cap that is large enough to prevent choking or ingestion. This is where the Baby Bottle Cap with a flared decorative rim comes in, and with the flared rim came the functions of a Teething surface, and a major advertising platform.

### BRIEF DESCRIPTIONS OF THE DRAWINGS

The File of this patent contains at least one drawing executed in color. Copies of this patent with color drawing(s) will be provided by the Patent and Trademark Office upon request and payment of the necessary fees.

FIG. 1 is a front view of the claimed Baby Bottle Cap showing the apparatus using a standard cap with universal threads and a nipple (actual nipple may vary depending on nature of the closure and its longevity).

FIG. 2 is a front view of Baby Bottle Caps with no flared rim. This drawing also shows the method of the cap's fit to the standard bottle (i.e., water bottles).

FIG. 3 is a front elevation view of a Universal Baby Bottle Cap with a flared rim in the shape of a flower, showing an example of a variety of shapes. showing the elements of physical operation as a teething apparatus in practice.

FIG. 4 is a top elevation view of the Universal Baby Bottle Cap showing variation is marketing and advertising capabilities (actual rim surface will vary). I claim no part of or any association to the sampled themes or their designs.

### DETAILED DESCRIPTION

THE NIPPLE—I designed my product using a Gerber All Purpose Nipple (but not limited to, many different brands work just the same). I modified the outer bottom edge of the nipple by cutting approximately 1 cm off the nipple base).

THE LID (The Fit)—The Universal Baby Bottle Cap fits most any regular 6-32 oz and 1-2 liter bottles with the 28 mm opening. I used a typical convert to squirt cap (otherwise known as a Sport Cap) on the market, the kind with the universal threads. I cut off the squirter/nubby portion of it, leaving it as simply a universal cap with an open hole. Next I inserted the nipple through the lid's hole and adhered them together. This apparatus remedied the need for a nippled cap (simplified version), however this could possibly be ingested, this is where the possible need for a flared rim came in (variation).

Variations:

A. SIMPLIFIED—The Baby Bottle Cap as mentioned in Detailed Description; Cap; numbers 1 and 2, together make the simplified version of the apparatus.

B. DELUXE—THE FLARED RIM—Since this apparatus is targeted toward a young consumer, I felt there may be a need for a safety measure due to the size of the simplified version. The addition of a flared rim (Baby Bottle Cap Deluxe Version), a variation of the apparatus, makes another way my product from other caps and their functions; my Unrversal Baby Bottle Cap can flare out at the bottom rim of the lid into a chewy disc or other ornate shape, which makes a great surface for advertising, marketing, and teething.

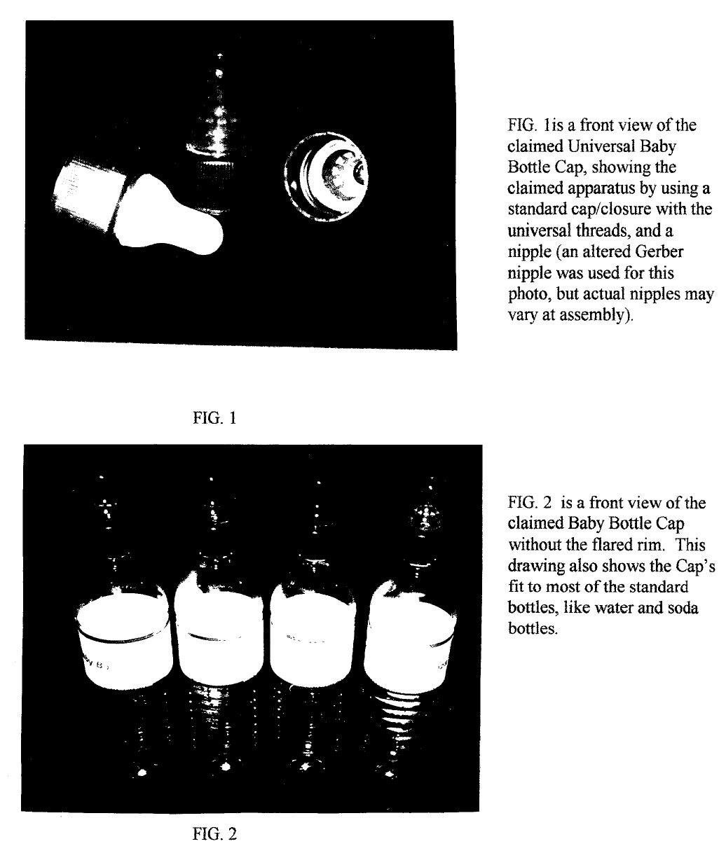

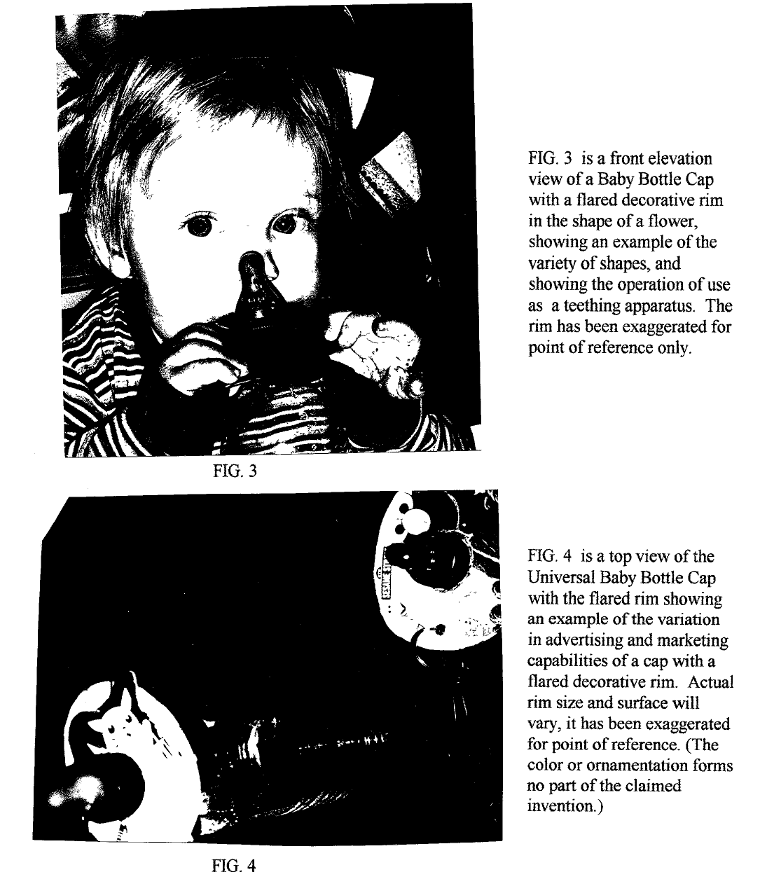

1. SHAPE—The flared rim can be made in a variety of fun shapes or animals . . . (flower shape in FIG. 1). This flared rim is large enough to prevent choking, size and shape may vary.

2. TEETHER—This decorative rim's waferly surface is approximately ⅓ of an inch thick, textured and chewy for teething purposes. Another way to occupy a toddler.

3. ADVERTISING SURFACE—The flared rim's surface can be designed in any number of themes including but not limited to; Rug Rats, Pokemon (seen as example in FIG. 4), Movies, McDonald's, Burger King, Sesame Street (seen as the clip-on your diaper bag and go version in FIG. 4), water bottle companies and advertising . . . A great multi-level marketing/financial opportunity (I do not claim any rights or connection with the aforementioned examples or companies).

C. DELUXE WITH KEY RING/CLIP ON DIAPER BAG—The Baby Bottle Caps with the flared rim can be manufactured with a hole for a key ring to be clipped to a diaper bag to be used in case of emergency or simply for the purpose of convenience.

D. OTHER MANUFACTURING VARIATIONS—Some companies may want to make a thinner one-piece plastic closed-nipple version of the Baby Bottle Cap as a more disposable version of packaging for bottles, in which the cap can just require a puncturing of the nipple hole when ready to use. This would be a one-piece mold, whereas the more durable and less disposable version would have a better nipple, like the Gerber Nipple Brites seen in FIG. 2 (I modified the outer rim of the nipple base by ½ cm). This more durable version will most likely have to be manufactured as two pieces, the nipple and the cap, which would then have to be adhered together during assembly of the product.

All parts of the Baby Bottle Cap will be one continues piece of plastic once it is assembled to insure it doesn't come apart and minimize leaking.

### Description of a Preferred Embodiment

The apparatus will be readily understood by those skilled in the cap/closure manufacturing arts and/or the Baby Bottle Industry upon a careful review of the drawings.

At the outset it must be observed that the apparatus is quite straight forward and relatively simple.

The simplicity and convenience is the heart of the invention since most mothers have probably been without all the utensils necessary to make up a bottle for their babies. As a parent or one who cares for children, it is apparent how frequently it becomes necessary to have to give a quick drink of something to a nursing or bottle feeding child without all of the hassle required to make up a baby bottle. Like for instance, driving on a road trip. Conveniently, the Universal Baby Bottle Cap (or Baby Bottle Cap) allows one to convert most of the store-bought water bottles, etc., into a baby bottle, internationally.

Now, in addition to the Cap fitting many of the bottled water, sodas, and juices; a mother could also easily give a small toddler formula. Just add a single-serving powder packet of formula to a bottle of drinking water, screw on the Baby Bottle Cap, shake, and start feeding. I see endless avenues of opportunity for the Baby Bottle Cap, but best of all, Kids will love them!

There is also another global need for a variation in bottle feeding as we know it, due to the existence of Bisphenol A, a leeching by-product that exists in over-used baby bottles, a problem that has been contaminating our bottles and polluting our children for decades. That is due to over-use, due to lack of alternatives. With a supply of Baby Bottle Caps, toddlers would be using less used bottles more of the time . . .

Again, some companies may want to make variations in the manufacturing durability and costs of the Baby Bottle Cap materials —I would like to disclose a disposable plastic closed-nipple version of the Baby Bottle Cap as a more disposable version for the closure packaging for bottles, in which the cap can just require a puncturing of the nipple hole when ready to use. This would be a one-piece mold, whereas the more durable and less disposable version would most likely have to be manufactured as two pieces, the nipple and the cap, and adhered together during the assembly of the product.

While the foregoing preferred embodiment and variations thereof are fully capable of achieving the objective and advantages desired, it is to be understood that they are for purposes of illustration only and not for purposes of limitation.

I claim:

1. A nippled cap apparatus with universal threads that provides a way to turn most standard bottles into a baby bottle.

2. The apparatus of a decorative rim at the bottom of a cap/closure's lid for the purpose of safety.

3. The apparatus of a decorative rim at the bottom of a cap/closure's lid for the purpose of a teething surface.

4. The apparatus of a decorative rim at the bottom of a cap/closure's lid for the purpose of an advertising platform.

5. The apparatus of a decorative rim at the bottom of the Baby Bottle Cap's lid for the purpose of safety.

6. The apparatus of a decorative rim at the bottom of the Baby Bottle Cap's lid for the purpose of a teething surface.

7. The apparatus of a decorative rim at the bottom of the Baby Bottle Cap's lid for the purpose of an advertising platform.

8. The method of claim 2 wherein the decorative rim is designed for safety and used for teething and advertising.

9. The method of claim 1 wherein the Baby Bottle Cap was put together.
